(19) United States
(12) Patent Application Publication
(10) Pub. No.: US 2006/0278274 A1
(43) Pub. Date: Dec. 14, 2006

(54) Protective device for faucet and method of making the same

(76) Inventor: Craig A. Heugel, Cincinnati, OH (US)

Correspondence Address: LAW OFFICE OF STEVEN B. LEAVITT, L.L.P.;ATTN: JOHN PEMBERTON, 7405 BUCKSKIN COURT, FORT WORTH, TX, 76137, US

(21) Appl. No.: 11/149,990

(22) Filed: Jun. 10, 2005

(51) Int. Cl. F16K 35/00

(52) U.S. Cl. 137/382

(57) ABSTRACT

The present invention is directed to a protective device for a faucet or other protrusion. The protective device includes a housing having a proximal end, a distal end and a lip located at the proximal end. The lip is capable of being attached to a surface such that the housing extends over or covers at least a portion of a faucet. The housing includes a top wall disposed between two side walls, wherein the housing has an inverted U-shape in transverse cross section. The device may include a detachable locking door. The invention is also directed to a method and kit for making the protective device.

### BACKGROUND OF THE INVENTION

1. Technical Field

This invention relates to protective devices, and more particularly, to a protective and security device for extensions protruding from an interior or exterior structure.

2. Description of Related Art

Limiting or preventing access to water system components is more imperative today than ever before. Exposed water faucets are frequently tampered with or vandalized resulting in thousands of gallons of wasted water each year. For example, remotely located hose bibbs are frequently the target of young people playing outdoors and neighbors and tenants watering their lawns or washing their cars. Many property and business owners pay an enormous price for this wasted water due to high utility bills. Furthermore, exposed faucets projecting out from walls are often in danger of being damaged, particularly when located outdoors or indoors around high traffic areas where various objects may come into contact with the faucet. What is needed is a device that can protect an exposed water faucet or other protrusion extending from an outside wall or interior structure. It would be beneficial if the device could be locked to prevent unauthorized entry.

### SUMMARY OF INVENTION

The present invention solves the above-described problem by providing a protective device that shields a faucet, and thereby prevents damage from occurring to the faucet. The device also prevents unauthorized access to a faucet and water supply.

The protective device of the present invention includes a housing having a proximal end, a distal end and a lip located at the proximal end. The lip is capable of being attached to a surface such that the housing extends over or covers at least a portion of a faucet. The housing preferably includes a top wall disposed between two side walls, wherein the housing has an inverted U-shape in transverse cross section.

More particularly, the protective device may include a support rod, and a detachable door in pivotal communication with the support rod. The detachable door is capable of being moved between an open position to allow access to the faucet and a closed position which prevents access to the faucet. In addition, the housing may include a locking mechanism receiver, and the detachable door may include a locking mechanism. The locking mechanism communicates with the locking mechanism receiver to lock and unlock the detachable door when the door is in a closed position.

Another aspect of the present invention is directed to a method of making a protective device for a faucet. The method includes providing a sheet having a top surface and a bottom surface. A lip is formed along the upper edge of the sheet such that the lip is perpendicular to the top surface of the sheet, and at least one notch is formed in the lip. In addition, at least one fold is made in the sheet to form a housing, wherein each fold is in longitudinal alignment with a notch. The housing defines an interior space sufficient to cover or extend over at least a portion of a faucet when the lip is attached to a surface proximate the faucet.

More particularly, the housing includes at least two side walls and a support rod. A detachable locking door may be pivotally mounted on the support rod, such that the detachable door may be moved between an open position which allows access to a faucet and a closed position which prevents access to the faucet.

Still, another aspect of the present invention is directed to a kit for making a protective device for a faucet. The kit includes a sheet having a first score line located along the upper edge of the sheet, wherein a lip may be formed by bending the sheet along the first score line. The sheet also includes at least one additional score line, wherein a housing may be formed by bending the sheet along the additional score line. Each additional score line is located perpendicular to the first score line on the sheet. A plurality of fasteners is provided for attaching the lip to a surface proximate a faucet.

The kit may further include a support rod. Also included in the kit is a locking mechanism receiver which may be attached to the housing, and a detachable locking door that is capable of being pivotally mounted on the support rod. The detachable door includes a locking mechanism that is capable of communicating with the locking mechanism receiver.

Other features and advantages of the present invention will become apparent upon reading the following detailed description of embodiments of the invention, when taken in conjunction with the appended claims.

### BRIEF DESCRIPTION OF THE DRAWINGS

FIG. 1 is a perspective view of a protective device made in accordance with an embodiment of the present invention.

FIG. 2 is a front view of the distal end of a protective device made in accordance with an embodiment of the present invention.

FIG. 3 is a side cross-sectional view of a protective device having a detachable locking door made in accordance with an embodiment of the present invention.

FIG. 4 is a front view of the distal end of the protective device of FIG. 3.

FIG. 5 is a top view of a sheet used to make a protective device in accordance with an embodiment of the present invention.

### DETAILED DESCRIPTION OF THE INVENTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

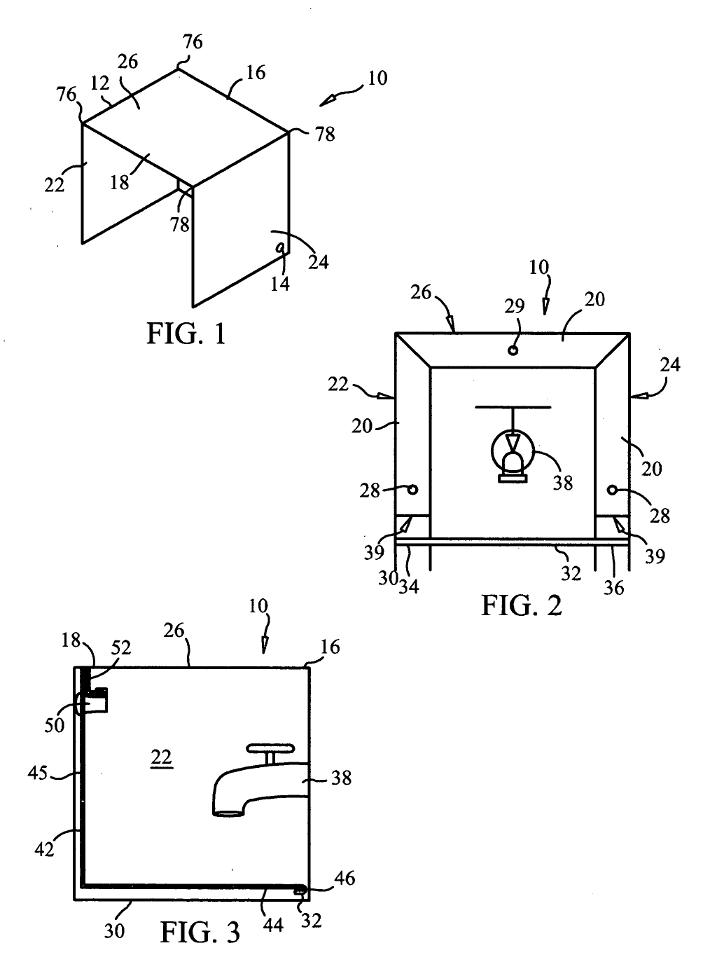

Referring to FIGS. 1 and 2, shown is a protective device 10 for a faucet comprising housing 12. Housing 12 includes proximal end 16, distal end 18, and lip 20 located at proximal end 16. Lip 20 is capable of being attached to a surface proximate a faucet, such that housing 12 covers or extends over at least a portion of the faucet. Lip 20 may be attached to a variety of walls, structures, or surfaces including, but not limited to brick, concrete, wood, plastic, cement, stone, glass, vinyl or metal siding. Lip 20 typically has a width between approximately 0.5 inch and approximately 2.0 inches. More preferably, lip 20 has a width between approximately 1.0 inch and 1.5 inches.

Housing 12 may be any shape or size which enables protective device 10 to effectively cover and protect at least a portion of the faucet after lip 20 is attached to a surface near the faucet. For example, housing 12 may be square, tubular, rectangular, or an aesthetically pleasing or ornamental shape. As illustrated in FIG. 1, a preferred embodiment of the present invention includes housing 12 having a first side wall 22, a second side wall 24, and a top wall 26 disposed between first side wall 22 and second side wall 24. In this configuration, housing 12 has an inverted U-shape in transverse cross section. Typically housing 12 has a length (or top wall 26 length) between about 3 inches and about 12 inches, a width (or top wall 26 width) between about 4 inches and about 12 inches, and a height (or first side wall 22 and second side wall 24 height) between about 3 inches and about 12 inches. Preferably, housing 12 has a length between about 4 inches and about 6 inches, a width between about 5 inches and about 6 inches, and a height between about 4 inches and about 6 inches. In a most preferred embodiment, housing 12 has a length of 6 inches, a width of 6 inches, and a height of 6 inches.

As stated above, protective device 10 is mounted about a faucet via lip 20. Lip 20 may be attached to a surface using any method known to those having skill in the art, including, but not limited to welding. In addition a variety of devices or substances may be used to attach lip 20 to a surface including, but not limited to adhesives such as glue, or fasteners such as anchors, screws, welding, blue tap-con screws, quick bolts, or dropping anchors. Tap-con screws are particularly useful for mounting lip 20 to surfaces such as concrete and brick. Lag screws and washers are useful when attaching lip 20 to wooden surfaces. As illustrated in FIG. 2, lip 20 may include at least one orifice 28 and 29 for inserting an anchor or screw therein when mounting protective device 10 to a surface. Preferably, lip 20 includes two orifices 28, each located on opposing sides of housing 12, and located approximately 2 inches from base 30 of protective device 10. Alternatively, orifices 28 may ideally be located on lip 20, X inches from base 30, where X equals one third the height of protective device 10. A third orifice 29, is preferably located in lip 20 near top wall 26 of housing 12, and located near the center of lip 20.

Referring to FIG. 2, protective device 10 of the present invention may further include support rod 32 which provides stability to housing 12 and helps to maintain the shape of housing 12. Support rod 32 includes a first end 34 and a second end 36. First end 34 of support rod 32 is located within orifice 14 located on first side wall 22. Second end 36 of support rod 32 is located within orifice 14 located on second side wall 24. First end 34 and second end 36 of support rod 32 may be spot or tack welded in place. Support rod 32 preferably has a diameter between about ⅛ inch and about ½ inch. Preferably, support rod 32 has a diameter between about ⅛ inch and about 3/32 inch and is made of a non-rusting material such as a steel rod with galvanized coating, stainless steel, aluminum, or copper.

As illustrated in FIG. 3, support rod 32 is desirably located near proximal end 16 of housing 12. More particularly, support rod 32 is mounted or welded to each side wall 22 and 24 from about ⅛ inch to about 5/16 inch from base 30 of housing 12, and about ¼ inch to about ⅜ inch from the proximal edge of housing 12. More preferably, support rod 32 is mounted or welded to each side wall ⅜ inch from base 30 of housing 12, and ⅜ inch from the proximal edge of housing 12. In addition, when housing 12 is mounted about faucet 38, support rod 32 is desirably located at least about 0.5 inch below the faucet outlet. More desirably, support rod 32 is located at least 1.0 inch below the faucet outlet. An indication line or mark 39 (see FIG. 2) may be included on housing 12 to indicate a height between 0.5 to 1.0 inch above support rod 32 in order to maintain the required distance between the faucet outlet and support rod to ensure door 42 properly functions.

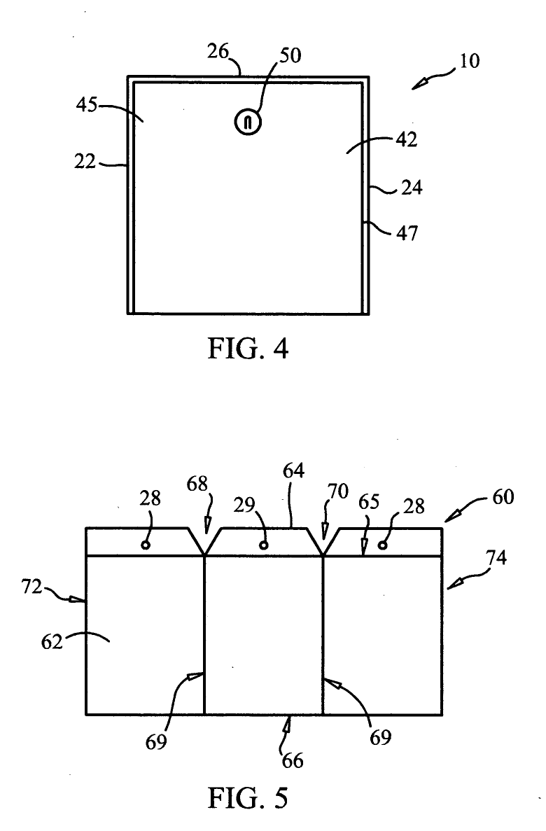

Protective device 10 of the present invention may further include detachable door 42 for completely enclosing housing 12 (see FIGS. 3 and 4). Detachable door 42 preferably comprises bottom portion 44 and upper portion 45, wherein bottom portion 44 and upper portion 45 form a right angle. Bottom portion 44 of detachable door 42 includes a hooked or curved end 46 which hooks around support rod 32, and thereby pivotally mounts detachable door 42 onto support rod 32. Detachable door 42 is capable of being moved between an open position which allows access to faucet 38, and a closed position (shown in FIGS. 3 and 4) which prevents access to faucet 38. Alternatively, detachable door 42 may be quickly and easily removed from housing 12, by unhooking bottom portion 44 of door from support rod 32. Bottom portion 44 may contain an area of felt, rubber or some other relatively absorbent material to prevent any paint on bottom portion 44 from rubbing off if bottom portion 44 were to hit the surface attached to housing lip 20.

Preferably, a gap 47 measuring from about ⅛ inch to about ½ inch is present between the edges of detachable door 42 and the interior surface of housing 12 when detachable door 42 is in a closed position. More preferably, a gap 47 measuring from about 1/16 inch to about ⅛ inch is present between the edges of detachable door 42 and interior surface of housing 12 when detachable door 42 is closed. Preferably gap 42 is as small as possible to prevent foreign objects such as children's fingers from gaining access to the interior of protective device 10 but large enough to dissipate moisture.

Locking mechanism 50 may be included on detachable door 42 to provide further security for protective device 10. Preferably, locking mechanism 50 is located on upper portion 45 of door 42. Locking mechanism 50 communicates with locking mechanism receiver 52 located on housing 12. Locking mechanism 50 and locking mechanism receiver 52 enable detachable door 42 to be locked and unlocked when door 42 is in a closed position. Any locking mechanism 50 and locking mechanism receiver 52 known to those having skill in the art may be used in the present invention. For example, the locking mechanism receiver 52 may be a recess in housing 12, or a 90° clip (as shown) attached to the interior surface of top wall 26 of housing 12. As illustrated in FIG. 3, locking mechanism 50 engages clip (or recess) 52 when detachable door 42 is closed and locking mechanism 50 is in a locked position, thus preventing detachable door 42 from being opened. Furthermore, locking mechanism receiver 52, may act as a stop that detachable door 42 rests against when detachable door 42 is in a closed position. In addition, a door handle may be included on detachable door 42 to provide assistance in opening detachable door 42. Preferably, the door handle is located on upper portion 45 of door 42. The door handle may be a knob, rope loop, or some other similar mechanism used to open detachable door 42.

The components of protective device 10 can be made of any suitable material that is rigid and durable enough to protect faucet 38 from injury. If protective device 10 is used outdoors, it is necessary for the components of the device to be made of materials able to withstand possible exposure to environmental elements such as sun, heat, wind or rain. Accordingly, suitable materials include, but are not limited to plastic, metal, metal with galvanized coating, stainless steel, wood, and fiberglass. Preferably, the components of protective device 10 are comprised of metal with a galvanized coating.

Protective device 10 of the present invention may be used in a variety of indoor or outdoor environments to prevent damage from occurring to faucets, including but not limited to hose bibbs. For example, protective device 10 may be used to shield faucets located inside or on the exterior walls of residential properties, commercial properties, rental properties, industrial buildings, schools, parks, stadiums and other recreational facilities. Protective device 10 is particularly useful in preventing damage to faucets located in high traffic areas, including but not limited to factories. In addition, protective device 10 of the present invention may be used as a security device in any of the environments described above to prevent unauthorized access to a faucet and water supply. Also, protective device 10 may have shelves on the interior of protective device 10 whereby the shelves can accommodate a spray nozzle or other relatively small tools.

Protective device 10 may also be utilized to protect and/or prevent unauthorized access to structures other than faucets, located in any of the above described environments. For example, protective device 10 may be used to protect and/or prevent access to a utility box, such as an outdoor electrical box. In addition, protective device 10 may be used to protect and/or prevent access to a vent such as a water heater or furnace vent or any other protrusion such as PVC or other piping, values, or handles. If used to protect a vent or other outlet or inlet where air flow is necessary or desired, at least a portion of housing 12 of protective device 10 is preferably comprised of a mesh material to allow air or other gas to escape. For example, all or a portion of detachable door 42 may be comprised of a mesh material. If the protective device 10 is used to protect PVC or other such piping the preferable dimensions are approximately 24 inches by approximately 24 inches. It should be obvious to those skilled in the art that a larger or smaller dimension may be used to protect a specific protrusion.

The present invention is also directed to a method of making protective device 10 described above. Referring to FIG. 5, a sheet 60 having a top surface 62, a bottom surface (not shown), an upper edge 64 and a lower edge 66 is provided. Sheet 60 may be comprised of any of the materials described above, and is preferably comprised of a bendable material. In addition sheet 60 typically has a length between about 6 inches and about 72 inches, a width between about 4 inches and about 14 inches, and a thickness between about 1/16 and about ⅛ inches. More preferably, sheet 60 has a length between approximately 18 inches and approximately 36 inches, a width between about 4 inches and about 12 inches, and a thickness between approximately 1/16 inches and approximately ¼ inches. In a most preferred embodiment, sheet 60 has a length of 18 inches, a width of 7 inches and a thickness of ⅛ inch.

Lip 20 (FIG. 2) is formed along upper edge 64 of sheet 60, wherein lip 20 is perpendicular to top surface 62 of sheet 60. Lip 20 is preferably formed by bending upper edge 64 of sheet 60, and may be formed by bending upper edge 64 along a preexisting score line 65 on sheet 60. At least one notch 68 is formed in upper edge 64 of sheet 60, wherein notch 68 will be located within lip 20. Preferably, notch 68 is formed in the shape of a wedge having a 45° angle.

At least one fold is made in sheet 60 to form housing 12, wherein each fold is in longitudinal alignment with notch 68 or 70. Notch 70 is the same as notch 68 expect in a different location. Each fold may be made along a preexisting score line 69 on the sheet 60. As sheet 60 is folded, each notch 68 and 70 enables lip 20 to maintain its perpendicular relationship with top surface 62 of sheet 60. Housing 12 is formed to define an interior space (see FIG. 2) sufficient to cover or extend over at least a portion of the faucet 38 when lip 20 is attached to a surface proximate the faucet 38. Preferably, a first fold is made in sheet 60 which is in longitudinal alignment with notch 68, and a second fold is made in sheet 60 which is in longitudinal alignment with notch 70. Notch 68 and the first fold are desirably located a distance from first side edge 72 of sheet 60 equal to one third the length of sheet 60. Similarly, notch 70 and the second fold are preferably located a distance from second side edge 74 of sheet 60 equal to one third the length of sheet 60. In other words, first notch 68/first fold and second notch 70/second fold are positioned to divide sheet 60 into equal thirds. Accordingly, housing 12 is formed having two side walls 22 and 24, a top wall 26, and an inverted U-shape in transverse cross section.

As shown in FIG. 1, the first fold forms two corners 76 in housing 12, and the second fold similarly forms two corners 78 in housing 12. Each housing corners 76 and 78 may be spot welded to help keep housing walls 22, 24 and 26 in place and maintain the shape of housing 12. In addition, support rod 32 may be used to stabilize housing 12. Support rod 32 may be attached to the interior surface of each side wall 22 and 24 by any method known to those having skill in the art. Preferably, support rod 32 is attached via welding. One method of adding support rod 32 includes inserting each end 34 and 36 of support rod 32 through orifice 14 in side walls 22 and 24, respectively, after housing 12 is formed. After support rod 32 is inserted it may be secured by a spot or tack weld.

Referring to FIG. 3, detachable door 42 may be pivotally mounted on support rod 32, such that detachable door 42 may be moved between an open position which allows access to a faucet and a closed position which prevents access to the faucet. Locking mechanism receiver 52 may be provided on housing 12, and locking mechanism 50 may be provided on detachable door 42. Locking mechanism 50 is capable of communicating with locking mechanism receiver 52 to lock and unlock detachable door 42 when detachable door 42 is in a closed position.

The present invention is also related to a kit for making a protective device 10 for a faucet. The kit includes a sheet 60 having a first score line 65 located along the upper edge 64 of sheet 60, such that a lip 20 may be formed by bending sheet 60 along the first score line. At least one additional score line 69 is located on sheet 60, wherein a housing 12 may be formed by bending sheet 60 along additional score line 69. Additional score line 69 is located perpendicular to the first score line 65. The score lines 65 and 69 may simply be a mark on the surface of sheet 60, or may be a shallow groove which aids in bending the sheet.

Sheet 60 may further include at least one notch 68 or 70 located at upper edge 64 of sheet 60. Each notch 68 and 70 is in longitudinal alignment with one of the score lines 65 and 69.

The kit of the present invention also includes a plurality of fasteners for attaching lip 20 to a surface proximate a faucet. Upper edge 64 of sheet 60 may include at least one orifice (or punch-out hole to form an orifice) 28, 29 for inserting a fastener therein, to aid in attaching lip 20 to a surface.

The kit of the present invention may further include support rod 32 for providing stability to housing 12, and detachable door 42 which may be pivotally mounted on support rod 32. If desired, detachable door 42 may include locking mechanism 50, and the kit may include locking mechanism receiver 52 which may be attached to housing 12.

It should be understood that the foregoing relates to exemplary embodiments of the invention and that modifications may be made without departing from the spirit and scope of the invention as set forth in the following claims.

What is claimed is:

1. A protective device for a faucet comprising:
a housing having a proximal end, a distal end, and a lip located at the proximal end,
the lip is capable of being attached to a surface such that the housing covers at least a portion of a faucet.

2. The protective device of claim 1, wherein the housing comprises at least two side walls and a top wall disposed between the two side walls, and the housing has an inverted U-shape in transverse cross section.

3. The protective device of claim 2, further comprising:
a support rod having a first end and a second end, the first end of the support rod is connected to the first side wall and the second end of the support rod is connected to the second side wall.

4. The protective device of claim 3, further comprising:
a detachable door in pivotal communication with the support rod, the detachable door is capable of being moved between an open position to allow access to the faucet and a closed position which prevents access to the faucet.

5. The protective device of claim 4, wherein the housing comprises a locking mechanism receiver, and the detachable door comprises a locking mechanism which communicates with the locking mechanism receiver to lock and unlock the detachable door when the door is in a closed position.

6. The protective device of claim 1, wherein the housing is comprised of metal, metal with galvanized coating, plastic, stainless steel, wood, or fiberglass.

7. The protective device of claim 1, wherein the housing has length from about 3 inches to about 12 inches, a width from about 4 inches to about 12 inches, and a height from about 3 inches to about 12 inches.

8. A method of making a protective device for a faucet comprising:
providing a sheet having a top surface and a bottom surface;
forming a lip along an upper edge of the sheet such that the lip is perpendicular to the top surface of the sheet;
forming at least one notch in the lip; and
making at least one fold in the sheet to form a housing, wherein each fold is in longitudinal alignment with a notch, and the housing defines an interior space sufficient to cover at least a portion of a faucet when the lip is attached to a surface proximate the faucet.

9. The method of claim 8, wherein the housing comprises at least two side walls, and a first end of a support rod is connected to the first side wall and a second end of the support rod is connected to the second side wall.

10. The method of claim 9, further comprising:
pivotally mounting a detachable door on the support rod, such that the detachable door may be moved between an open position which allows access to a faucet and a closed position which prevents access to the faucet.

11. The method of claim 9, further comprising:
providing a locking mechanism receiver on the housing; and
providing a locking mechanism on the detachable door, the locking mechanism is capable of communicating with the locking mechanism receiver to lock and unlock the door when the detachable door is in a closed position.

12. The method of claim 8, wherein there are two folds and the first fold and the second fold each form two corners in the housing creating an inverted U-shape in transverse cross section, the housing having a top wall and two opposing side walls and each corner is spot welded.

13. The method of claim 12, further comprising:
attaching one end of a support rod to the first side wall and attaching the other end of the support rod to the second side wall by a spot weld.

14. The method of claim 13, further comprising:
pivotally mounting a detachable door on the support rod, such that the detachable door may be moved between an open position which allows access to a faucet and a closed position which prevents access to a faucet.

15. The method of claim 14, further comprising:
providing a locking mechanism receiver on the housing; and
providing a locking mechanism on the detachable door, the locking mechanism is capable of communicating with the locking mechanism receiver to lock and unlock the door when the detachable door is in a closed position.

16. A kit for making a protective device for a faucet comprising:
a sheet comprising:
a first score line located along an upper edge of the sheet such that a lip may be formed by bending the sheet along the first score line;
at least one additional score line such that a housing may be formed by bending the sheet along the additional score line, and wherein the additional score line is located perpendicular to the first score line; and
a plurality of fasteners for attaching the lip to a surface proximate a faucet.

17. The kit of claim 16, wherein the sheet further comprises at least one notch located at the upper edge of the sheet, and the notch is in longitudinal alignment with one of the additional score lines.

18. The kit of claim 16, wherein the upper edge of the sheet further comprises at least one orifice for inserting a fastener therein to attach the housing lip the surface.

19. The kit of claim 16, further comprising a support rod for attachment to a first side wall and a second side wall of the housing.

20. The kit of claim 19, further comprising:
a locking mechanism receiver which may be attached to the housing; and
a detachable locking door that is capable of being pivotally mounted on the support rod, the detachable door having a locking mechanism that is capable of communicating with the locking mechanism receiver.
